(19) United States
(12) Patent Application Publication
(10) Pub. No.: US 2020/0061505 A1
(43) Pub. Date: Feb. 27, 2020

(54) Bidirectional Split Flow Fluid Phase Separation System

(71) Applicant: Ronald Allen Hodge, New Waterford, OH (US)

(72) Inventor: Ronald Allen Hodge, New Waterford, OH (US)

(21) Appl. No.: 16/547,533

(22) Filed: Aug. 21, 2019

Related U.S. Application Data
(60) Provisional application No. 62/720,830, filed on Aug. 21, 2018.

(51) Int. Cl. B01D 45/02

(52) U.S. Cl. CPC B01D 45/02

(57) ABSTRACT

A bidirectional split flow fluid phase separation system is used to improve the gravity settling method. The bidirectional split flow fluid phase separation system comprises a structural base, at least one separation chamber, at least one multi-phase flow inlet, at least one gas flow outlet, and at least one liquid-drop outlet. The structural base is used to support the at least one separation chamber. The at least one separation chamber is used to separate a multi-phase flow into a gas phase flow and a liquid phase flow. The at least one multi-phase flow inlet is used to receive the multi-phase flow. The at least one gas flow outlet is used to output the separated gas phase flow. The at least one liquid-drop outlet is used to output the separated liquid phase flow.

The current application claims a priority to the U.S. Provisional Patent application Ser. No. 62/720,830 filed on Aug. 21, 2018.

### FIELD OF THE INVENTION

The present invention generally relates to natural gas and oil processing systems and methods. More specifically, the present invention relates to phase separation systems in natural gas and oil processing. The present invention aims to improve on the conventional gravity settling separation method.

### BACKGROUND OF THE INVENTION

Separation equipment in natural gas and oil processing equipment is used to separate gas, liquids, solids, or a combination of these phases. Separation of these phases is typically done by individual separation methods or a combination of various separation methods. The traditional separation methods are momentum, gravity settling, and coalescing. For any of these methods to work, the fluid phase must be immiscible and have different densities.

The gravity settling method typically takes place in a horizontal or vertical fluid separation chamber, typically a formed shell-cylinder or pipe which is generally under pressure. If a liquid is to be separated from a gas, the terminal velocity of the droplet size to be removed needs to be determined. In a horizontal separation chamber, the velocity of the incoming volumetric flow rate “Q” needs to slow down to an acceptable velocity where the calculated liquid droplet's terminal velocity can reach the bottom of separation chamber where the droplet can be stored or drained. The velocity must be slow enough to allow this settling (dropout) of the droplet to happen before the fluid phase leaves the chamber with said droplet (through an outlet). Velocity in the separation chamber is a function of the given volumetric flow rate divided by the available cross section of the separation chamber. This is a linear relationship. For example, to cut the velocity in half, the cross-sectional area must be doubled, or the volumetric flow rate must be cut in half.

Typical separation chambers have an inlet at one end of the separation chamber and an outlet at the other end. The flow in a typical separation chamber is in one direction (unidirectional), and velocity is simply the volumetric flow rate divided by the chamber's available cross-sectional area. The separated fluid phase remains in the separation chamber until drained or “dumped.” In the case of a “harp style” separator/slug catcher, the separation chamber is at a higher elevation than its “storage fingers”. This difference in elevation in the “harp style” is achieved through elbow fittings of typically the same diameter or smaller. In all scenarios, if the separated fluid remains in the separation chamber, the effective cross-section of the chamber is reduced and the drop-out height for the droplet affected. Velocity and drop-out times need to be calculated for worst case scenarios.

Typically, separation chambers can be longer to allow for needed drop-out time, but velocity has an upper limit for processing functionality, so the available cross-sectional area typically drives the design of fluid phase separation chambers.

An objective of the present invention is to make the gravity settling method in a horizontal separation chamber more cost effective. The present invention does this by splitting (halving) the incoming primary volumetric flow in opposite directions prior to entering the separation chamber or immediately upon entry. This splitting of the primary flow through the separation chamber shall be collectively called bidirectional flow, in contrast to unidirectional separation chambers available currently (where flow is in one direction across the separation chamber).

Splitting of the flow in the present invention is done by one of two means. The first option (means) is to have the primary incoming flow split before the separation chamber (for instance in a lower liquid holding chamber). In this case, the two split flows would enter at the ends of the separation chamber, in inlets of at least half of the original cross-sectional area of the primary incoming flow (split flow inlets), and subsequently flow towards each other (towards the center of the separation chamber). The single primary gas flow outlet would be located approximately in the center and on top of the separation chamber, most likely the same cross-sectional area of the primary incoming flow prior to being split. The second means to create a bidirectional flow is to bring the primary incoming flow into the center of the separation chamber and split the primary flow into opposite directions. The splitting of the primary incoming flow could be done prior to entry of the separation chamber or upon entry with a flow diverter located inside the separation chamber. The primary outlet flows would be located on opposite ends and on top of the separation chamber. These outlet flows should be at least half the cross-sectional area of the primary inlet flow since there are two outlet flows compared to one inlet flow. Outside of the separation chambers, these two outlet flows could be brought back together to achieve a singular primary outlet flow point, most likely the same cross-sectional area of the primary incoming flow.

In the first scenario, the primary flow is typically introduced into a slug catcher/liquid storage chamber. This chamber acts as a buffer for slug like events and keeps the separation chamber devoid of temporary liquid level increase (which could affect separation efficiency). The second scenario, the primary flow is introduced directly into the separation chamber. This scenario would be more applicable to steady state flow(s), without sudden liquid level fluctuations.

In either scenario (primary incoming flow split prior to the separation chamber and entering the ends of the separation chamber, or primary incoming flow entering the middle of separation chamber and separated) the incoming primary flow through the singular separation chamber is split in half via bidirectional flow, causing the velocity to be split in half for a given cross sectional area of the separation chamber.

Compared to a unidirectional flow separation chamber, volumetric flow can be doubled while maintaining the same velocity. Conversely, given a fixed volumetric flow rate, the cross-sectional area required can be split in half (compared to a typical unidirectional flow separation chamber). In either of the aforementioned scenarios, the bidirectional flow separation chambers should result in cost reductions in the separation chamber construction due to the smaller required diameter.

Furthermore, to maintain the full cross section of the separation chamber, the separated liquids are constantly draining to a lower level or adjacent slug catcher/liquid storage chamber through one or more liquid dropouts that are located on the bottom of the separation chamber. Even if the bidirectional flow separation chamber needs to be longer than a unidirectional chamber for drop out time requirements, savings should be realized due to the disproportionate cost of increasing the diameter on pressure chambers versus lengthening.

### BRIEF DESCRIPTION OF THE DRAWINGS

FIG. 1 is a schematic view of the present invention.

FIG. 2 is a schematic view of the first embodiment of the present invention.

FIG. 3 is an exemplary perspective view of the first embodiment of the present invention.

FIG. 4 is a schematic view of the second embodiment of the present invention.

FIG. 5 is an exemplary perspective view of the second embodiment of the present invention.

FIG. 6 is an exemplary perspective view of the third embodiment of the present invention.

### DETAIL DESCRIPTIONS OF THE INVENTION

All illustrations of the drawings are for the purpose of describing selected versions of the present invention and are not intended to limit the scope of the present invention.

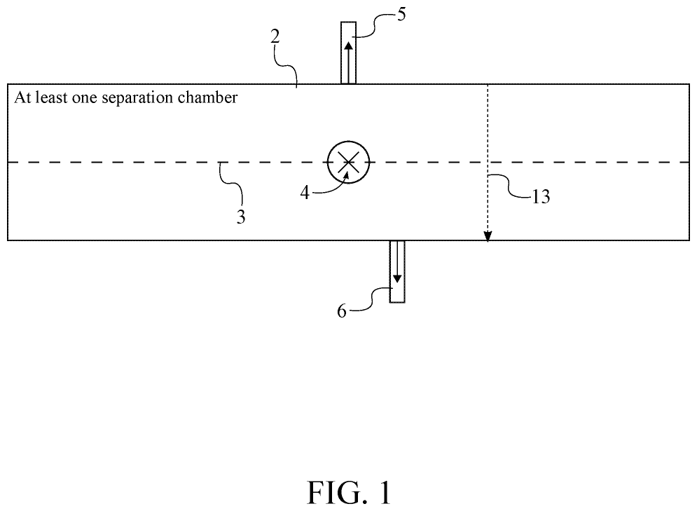

In reference to FIGS. 1 through 6, the present invention is a bidirectional split flow fluid phase separation system that improves the gravity settling method. The present invention comprises a structural base 1, at least one separation chamber 2, at least one multi-phase flow inlet 4, at least one gas flow outlet 5, and at least one liquid-drop outlet 6. The structural base 1 is used to support the at least one separation chamber 2. The at least one separation chamber 2 is used to separate a multi-phase flow into a gas phase flow and a liquid phase flow. The at least one multi-phase flow inlet 4 is used to receive the multi-phase flow. The at least one gas flow outlet 5 is used to output the separated gas phase flow. The at least one liquid-drop outlet 6 is used to output the separated liquid phase flow.

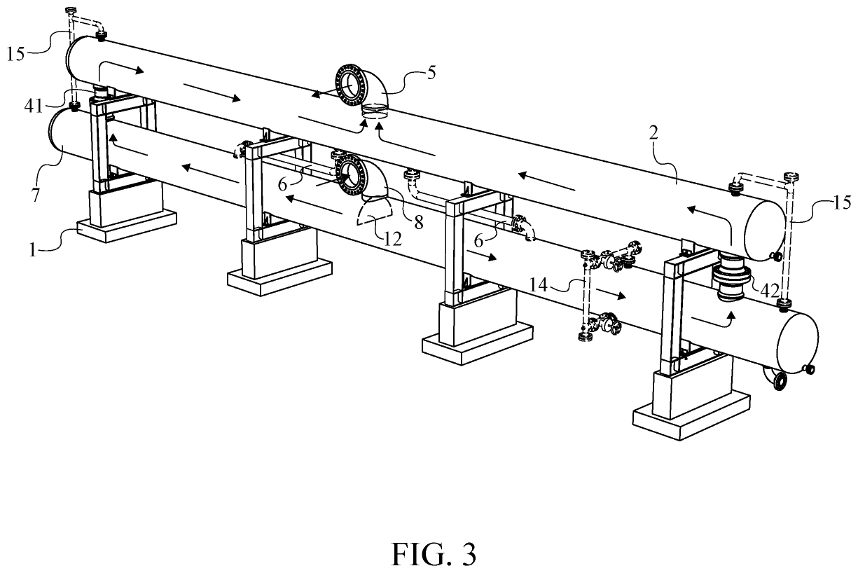

The general configuration of the aforementioned components allows the present invention to improve the gravity settling method. With reference to FIG. 1, the at least one separation chamber 2 is preferably a cylindrical chamber in order to allow efficient flow of the multi-phase flow. The at least one multi-phase flow inlet 4 is mounted in between the structural base 1 and the at least one gas flow outlet 5. This arrangement positions the at least one gas flow outlet 5 above the multi-phase flow inlet 4 in order for the gravity settling method to be effective. The at least one multi-phase flow inlet 4 and the at least one gas flow outlet 5 are in fluid communication with each other through at least one separation chamber 2. This arrangement allows the multi-phase flow to be separated into the gas phase flow. The at least one multi-phase flow inlet 4 and the at least one liquid-drop outlet 6 are in fluid communication with each other through the at least one separation chamber 2. This arrangement allows the multi-phase flow to be separated into the liquid phase flow. The at least one liquid-drop outlet 6 and the at least one gas flow outlet 5 is positioned opposite to each other about the at least one separation chamber 2. This arrangement allows the liquid phase flow to be separated towards the bottom of the at least one separation chamber 2 and the gas phase flow to be separated towards the top of that least one separation chamber 2 through the gravity settling method. Further and with reference to FIG. 3, the at least one separation chamber 2 is mounted onto the structural base 1 in order for the at least one separation chamber 2 to be properly supported. Moreover and in the preferred embodiment of the present invention, a central axis 3 of the at least one separation chamber 2 is positioned perpendicular to a plumb direction 13. Thus, the at least one separation chamber 2 is configured as a horizontal cylindrical chamber.

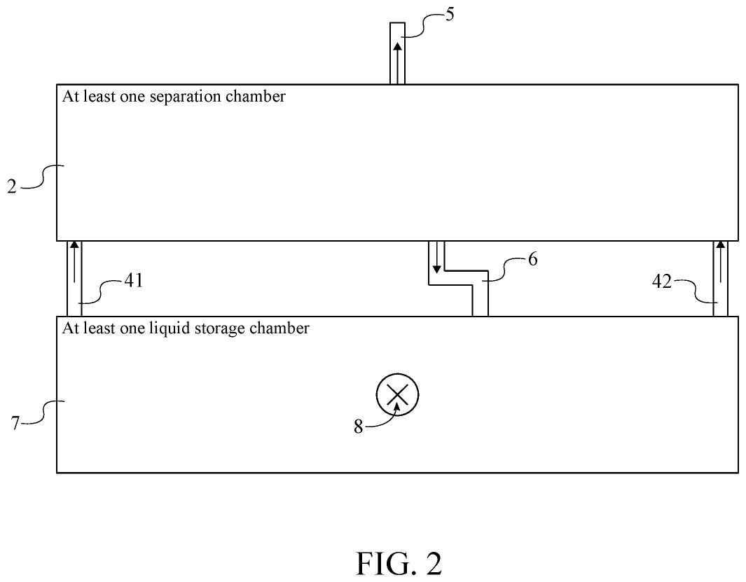

In a first embodiment of the present invention and with reference to FIGS. 2 and 3, the at least one multi-phase flow inlet 4 comprises a first multi-phase inlet 41 and a second multi-phase inlet 42. Further in the first embodiment, the at least one gas flow outlet 5 is a single gas outlet. The first multi-phase inlet 41 and the second multi-phase inlet 42 are positioned opposite to each other along the at least one separation chamber 2. This arrangement is used to equally split the multi-phase flow through each the first multi-phase inlet 41 and the second multi-phase inlet 42. In further detail, half of the multi-phase flow enters through the first multi-phase inlet 41 and the other half of the multi-phase flow enters through the second multi-phase inlet 42. This further allows the velocity of the multi-phase to be reduced in half when entering into the at least one separation chamber 2. The single gas outlet is equidistantly positioned in between the first multi-phase inlet 41 and the second multi-phase inlet 42. This arrangement allows both halves of the multi-phase flow to flow towards the center of the at least one separation chamber 2.

Further in the first embodiment and with reference to FIGS. 2 and 3, the present invention may further comprise at least one liquid storage chamber 7. The at least one liquid storage chamber 7 is used to receive the separated liquid phase flow and in the first embodiment, the at least one liquid storage chamber 7 aids in splitting the multi-phase flow. The at least one liquid storage chamber 7 comprises a main multi-phase inlet 8. In the first embodiment, the multi-phase first enters through the main multi-phase inlet 8. The main multi-phase inlet 8 is equidistantly positioned in between the first multi-phase inlet 41 and the second multi-phase inlet 42. This arrangement allows the multi-phase flow to be split before flowing into the first multi-phase inlet 41 and the second multi-phase inlet 42. The main multi-phase inlet 8 is in fluid communication with the first multi-phase inlet 41 and the second multi-phase inlet 42 through the at least one liquid storage chamber 7. This arrangement allows the multi-phase flow to freely flow into and out of the at least one liquid storage chamber 7. Further, the at least one liquid storage chamber 7 is in fluid communication with the at least one separation chamber 2 through the first multi-phase inlet 41 and the second multi-phase inlet 42. This allows the multi-phase flow to flow from the at least one liquid storage chamber 7 and into the at least one separation chamber 2. In further detail, the multi-phase flow is split through the at least one liquid storage chamber 7 before flowing into the at least one separation chamber 2. In an exemplary version of the first embodiment, the at least one liquid storage chamber 7 is mounted onto and is positioned in between the at least one separation chamber 2 and the structural base 1. This arrangement allows the at least one liquid storage chamber 7 to be properly supported. Also, this arrangement allows the at least one liquid storage chamber 7 to receive the liquid phase flow through the gravity settling method.

Further in the first embodiment with reference to FIG. 3, the present invention may further comprise a flow splitter 12. The flow splitter 12 is a device used to split the multi-phase flow into two, separate, and approximately equal opposite flows. The flow splitter 12 is mounted adjacent to the main multi-phase inlet 8. This arrangement allows the flow splitter 12 to aid in evenly splitting the multi-phase flow throughout the at least one liquid storage chamber 7 before flowing into the at least one separation chamber 2. Further, the main multi-phase inlet 8 is in fluid communication with the flow splitter 12. Thus, the multi-phase flow flows into the main multi-phase inlet 8 and towards the flow splitter 12 to be split throughout the at least one liquid storage chamber 7.

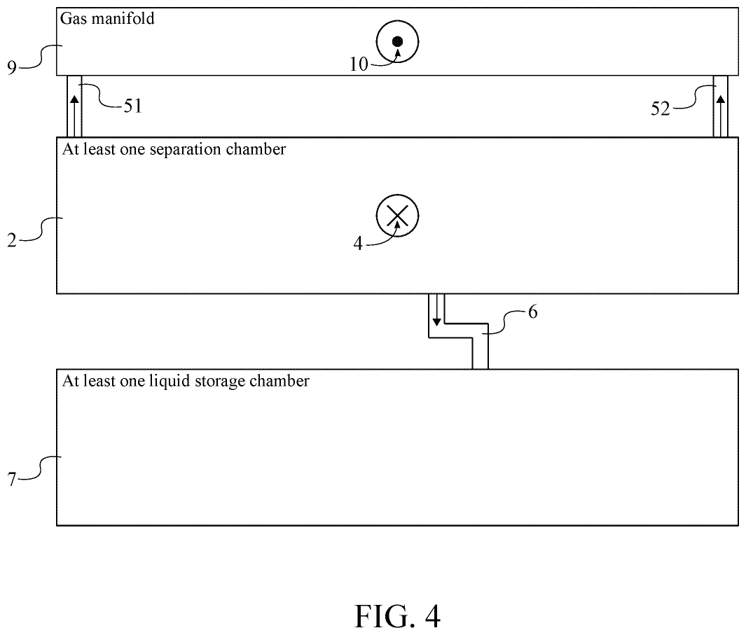

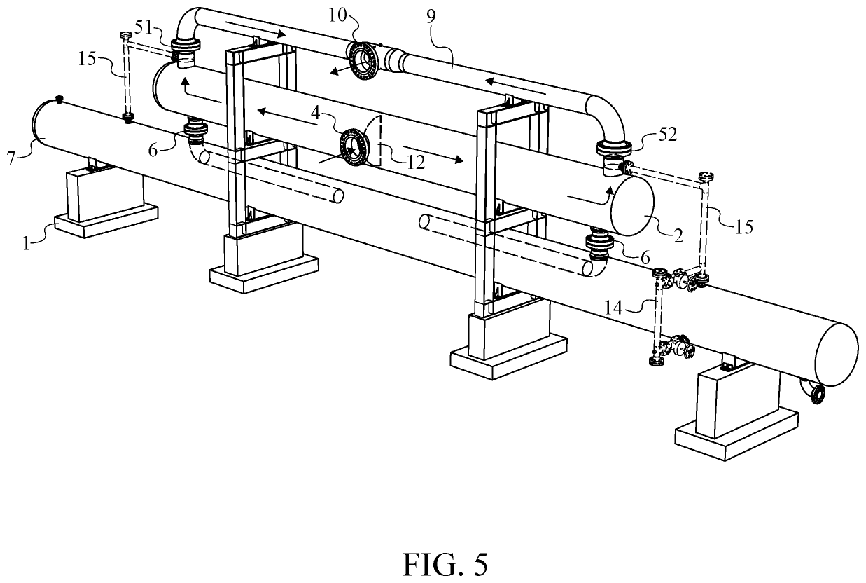

In a second embodiment of the present invention with reference to FIGS. 4 and 5, the at least one multi-phase flow inlet 4 is a single multi-phase inlet. Thus, the multi-phase flow first enters the at least one separation chamber 2 in the second embodiment. Further in the second embodiment, the at least one gas flow outlet 5 comprises a first gas outlet 51 and a second gas outlet 52. The first gas outlet 51 and the second gas outlet 52 are positioned opposite to each along the at least one separation chamber 2. This arrangement is used to equally split the multi-phase flow out of the first gas outlet 51 and the second gas outlet 52. Further, this arrangement allows the velocity of the multi-phase flow to be reduced in half as the multi-phase flow flows out of the at least one separation chamber 2. Further, the single multi-phase inlet is equidistantly positioned in between the first gas outlet 51 and the second gas outlet 52. This arrangement evenly splits the multi-phase flow as it flows into and through the at least one separation chamber 2.

With reference to FIG. 5, the second embodiment may include the flow splitter 12. In the second embodiment, the flow splitter 12 is mounted adjacent to the single multi-phase inlet. The flow splitter 12 is used to split the multi-phase flow into two, separate, and approximately equal opposite flows as the multi-phase flow flows into the at least one separation chamber 2. The single multi-phase inlet is in fluid communication with the flow splitter 12. Thus, the multi-phase flow flows into the single multi-phase inlet and towards the flow splitter 12 to be split throughout the at least one separation chamber 2.

Further in the second embodiment, the present invention may further comprise a gas manifold 9. The gas manifold 9 is used to combine the gas phase flow being outputted through the first gas outlet 51 and the second gas outlet 52. The gas manifold 9 comprises a main gas outlet 10. In the second embodiment, the gas phase flow is ultimately outputted through the main gas outlet 10. The at least one separation chamber 2 is in fluid communication with the gas manifold 9 through the first gas outlet 51 and the second gas outlet 52. This arrangement allows the gas phase flow to flow from the at least one separation chamber 2 and into the gas manifold 9. Half of the gas phase flow is outputted through first gas outlet 51 and the other half of the gas phase flow is outputted through the second gas outlet 52. The main gas outlet 10 is positioned equidistantly positioned in between the first gas outlet 51 and the second gas outlet 52. Thus, both halves of the gas phase flow are outputted through the gas manifold 9.

In some embodiments and with reference to FIGS. 2 and 4, the at least one liquid storage chamber 7 is used to receive the liquid phase flow. Thus, the at least one liquid storage chamber 7 is in fluid communication with the at least one separation chamber 2 through the at least one liquid-drop outlet 6. In further detail, this arrangement allows the separated liquid phase flow to flow from the at least one separation chamber 2 and into the at least one liquid storage chamber 7. Moreover, through the gravity settling method, the liquid phase flow travels towards the bottom of the at least one separation chamber 2 to flow into the at least one liquid storage chamber 7.

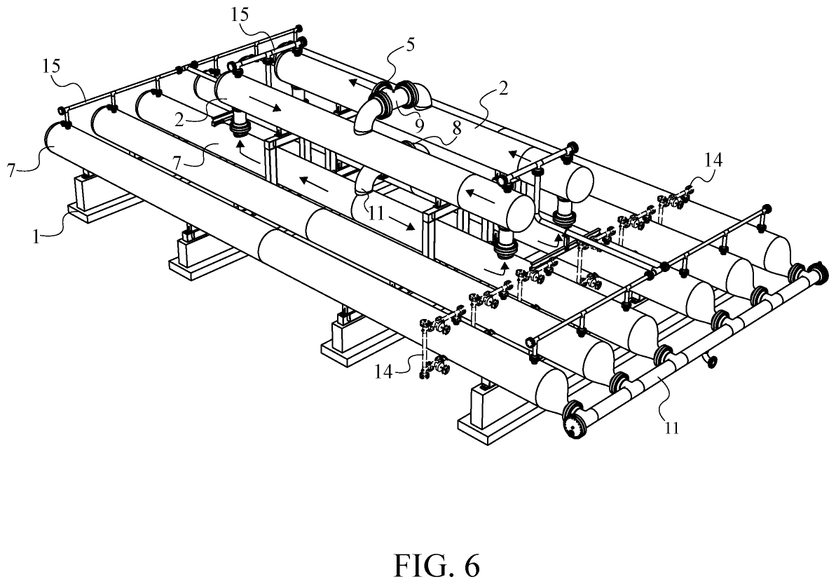

In a third embodiment of the present invention and with reference to FIG. 6, the at least one separation chamber 2 is a plurality of separation chambers 2. Further, the third embodiment includes the gas manifold 9. The third embodiment is typically used when the volume of the multi-phase flow is large. Each of the plurality of separation chambers 2 is in fluid communication with the at least one gas flow outlet 5 through the gas manifold 9. Thus, the gas phase flow is distributed out of each of the plurality of separation chambers 2, combined throughout the gas manifold 9, and ultimately outputted by the gas manifold 9.

Further in the third embodiment and with reference to FIG. 6, the present invention may further comprise a fluid manifold 11. The fluid manifold 11 is used to combine the multi-phase flow inlets of the present invention. Further in the third embodiment, the present invention may further comprise a plurality of liquid storage chambers 7. The plurality of liquid storage chambers 7 is used to receive the separated liquid phase flow. Each of the plurality of liquid storage chambers 7 comprises a main multi-phase inlet 8. The fluid manifold 11 is in fluid communication with each of the plurality of liquid storage chambers 7 through the main multi-phase inlet 8. Thus, the fluid manifold 11 combines the main multi-phase inlet 8 of each of the plurality of liquid storage chambers 7. Further, the multi-phase flow first enters the fluid manifold 11 in the third embodiment. In an exemplary version of the third embodiment, the plurality of liquid storage chambers 7 is mounted onto the structural base 1 in order to be properly supported. Each of the plurality of liquid storage chambers 7 is positioned in between a corresponding chamber from the plurality of separation chambers and the structural base 1. Further, the fluid manifold 11 is positioned in between the gas manifold 9 and the structural base 1. This arrangement allows the gravity settling method to be properly processed by the present invention.

With reference to FIGS. 3 and 5, the present invention may further comprise at least one bridle 14. The least one bridle 14 is used to measure and adjust the fluid level within the at least one liquid storage chamber 7. Moreover, the at least one bridle 14 is in fluid communication with the at least one liquid storage chamber 7. This arrangement allows the fluid level inside the bridle 14 to be equally adjusted, in scale, with the fluid level inside the at least one liquid storage chamber 7.

With reference to FIGS. 3 and 5, the present invention may further comprise at least one gas vent 15. The at least one gas vent 15 is used to keep flow regiment and pressure drop approximately balanced throughout the at least one separation chamber 2. The at least one separation chamber 2 is in fluid communication with the at least one gas vent 15. This allows gas to be released from the at least one separation chamber 2 and out the at least one gas vent 15.

With reference to FIGS. 3 and 5, the at least one gas vent 15 is also used to keep flow regiment and pressure drop approximately balanced throughout the at least one liquid storage chamber 7. Thus, the at least one liquid storage chamber 7 is in fluid communication with the at least one gas vent 15. This allows gas to be released from the at least one liquid storage chamber 7 and out the at least one gas vent 15.

In another embodiment of the present invention, the at least one liquid storage chamber 7 may comprise a liquid outlet. The liquid outlet is used to output the separated liquid from the multi-phase flow. In embodiments where the at least one liquid storage chamber 7 is a plurality of liquid storage chambers 7, the present invention may further comprise a liquid manifold. The liquid manifold is used to combine the outlets of each of the plurality of liquid storage chambers 7. The liquid manifold is in fluid communication with each of the plurality of liquid storage chambers 7 through the liquid outlet. This allows the separated liquid from each of the plurality of liquid storage chambers 7 to be outputted by the liquid manifold.

Although the invention has been explained in relation to its preferred embodiment, it is to be understood that many other possible modifications and variations can be made without departing from the spirit and scope of the invention as hereinafter claimed.

What is claimed is:

1. A bidirectional split flow fluid phase separation system comprises:
a structural base;
at least one separation chamber;
at least one multi-phase flow inlet;
at least one gas flow outlet;
at least one liquid-drop outlet;
the at least one separation chamber being a cylindrical chamber;
the at least one multi-phase flow inlet being mounted in between the structural base 1 and the at least one gas flow outlet;
the at least one multi-phase flow inlet and the at least one gas flow outlet being in fluid communication with each other through the at least one separation chamber;
the at least one multi-phase flow inlet and the at least one liquid-drop outlet being in fluid communication with each other through the at least one separation chamber;
the at least one liquid-drop outlet and the at least one gas flow outlet being positioned opposite to each other about the at least one separation chamber; and
the at least one separation chamber being mounted onto the structural base.

2. The bidirectional split flow fluid phase separation system as claimed in claim 1 comprises:
a central axis of the at least one separation chamber being positioned perpendicular to a plumb direction.

3. The bidirectional split flow fluid phase separation system as claimed in claim 1 comprises:
the at least one multi-phase flow inlet comprises a first multi-phase inlet 4 and a second multi-phase inlet;
the at least one gas flow outlet being a single gas outlet;
the first multi-phase inlet and the second multi-phase inlet being positioned opposite to each other along the at least one separation chamber; and
the single gas outlet being equidistantly positioned in between the first multi-phase inlet and the second multi-phase inlet.

4. The bidirectional split flow fluid phase separation system as claimed in claim 3 comprises:
at least one liquid storage chamber;
the at least one liquid storage chamber comprises a main multi-phase inlet;
the main multi-phase inlet being equidistantly positioned in between the first multi-phase inlet and the second multi-phase inlet;
the main multi-phase inlet being in fluid communication with the first multi-phase inlet and the second multi-phase inlet through the at least one liquid storage chamber;
the at least one liquid storage chamber being in fluid communication with the at least one separation chamber through the first multi-phase inlet; and
the at least one liquid storage chamber being in fluid communication with the at least one separation chamber through the second multi-phase inlet.

5. The bidirectional split flow fluid phase separation system as claimed in claim 4 comprises:
a flow splitter;
the flow splitter being mounted adjacent to the main multi-phase inlet; and
the main multi-phase inlet being in fluid communication with the flow splitter.

6. The bidirectional split flow fluid phase separation system as claimed in claim 1 comprises:
the at least one multi-phase flow inlet being a single multi-phase inlet;
the at least one gas flow outlet comprises a first gas outlet and a second gas outlet;
the first gas outlet and the second gas outlet being positioned opposite to each other along the at least one separation chamber; and
the single multi-phase inlet being equidistantly positioned in between the first gas outlet and the second gas outlet.

7. The bidirectional split flow fluid phase separation system as claimed in claim 6 comprises:
a flow splitter;
the flow splitter being mounted adjacent to the single multi-phase inlet; and
the single multi-phase inlet being in fluid communication with the flow splitter.

8. The bidirectional split flow fluid phase separation system as claimed in claim 6 comprises:
a gas manifold;
the gas manifold comprises a main gas outlet;
the at least one separation chamber being in fluid communication with the gas manifold through the first gas outlet;
the at least one separation chamber being in fluid communication with the gas manifold through the second gas outlet; and
the main gas outlet being equidistantly positioned in between the first gas outlet and the second gas outlet.

9. The bidirectional split flow fluid phase separation system as claimed in claim 1 comprises:
at least one liquid storage chamber; and
the at least one liquid storage chamber being in fluid communication with the at least one separation chamber through the at least one liquid drop outlet.

10. The bidirectional split flow fluid phase separation system as claimed in claim 1 comprises:
a gas manifold;
the at least one separation chamber being a plurality of separation chambers; and
each of the plurality of separation chambers being in fluid communication with the at least one gas flow outlet through the gas manifold.

11. The bidirectional split flow fluid phase separation system as claimed in claim 10 comprises:
a fluid manifold;
a plurality of liquid storage chambers;
each of the plurality of liquid storage chambers comprises a main multi-phase inlet;
the fluid manifold being in fluid communication with each of the plurality of liquid storage chambers through the main multi-phase inlet; and
the fluid manifold being positioned in between the gas manifold and the structural base.

12. The bidirectional split flow fluid phase separation system as claimed in claim 1 comprises:
at least one liquid storage chamber;
at least one bridle;
the at least one liquid storage chamber being fluid communication with the at least one separation chamber; and
the at least one bridle being in fluid communication with the at least one liquid storage chamber.

13. The bidirectional split flow fluid phase separation system as claimed in claim 1 comprises:
at least one gas vent; and
the at least one separation chamber being in fluid communication with the at least one gas vent.

14. The bidirectional split flow fluid phase separation system as claimed in claim 1 comprises:
at least one liquid storage chamber;
at least one gas vent;
the at least one liquid storage chamber being fluid communication with the at least one separation chamber; and
the least one liquid storage chamber being in fluid communication with the at least one gas vent.
